(19) United States
(12) Patent Application Publication
(10) Pub. No.: US 2005/0180749 A1
(43) Pub. Date: Aug. 18, 2005

(54) System and method for a resilient optical Ethernet networksupporting automatic protection switching

(76) Inventors: Bikash Koley, Greenbelt, MD (US); Si-Hyung Cho, Frederick, MD (US)

Correspondence Address: DLA PIPER RUDNICK GRAY CARY US LLP, P. O. BOX 9271, RESTON, VA, 20195, US

(21) Appl. No.: 10/981,572

(22) Filed: Nov. 5, 2004

Related U.S. Application Data
(60) Provisional application No. 60/518,503, filed on Nov. 7, 2003.

(51) Int. Cl. H04J 14/00

(52) U.S. Cl. 398/45

(57) ABSTRACT

A system and method is provided for operating a node in an optical Ethernet network system, comprising: generating optical signals of at least one wavelength corresponding to the node; transmitting the optical signals on each of the first and second optical fiber paths; receiving optical signals of the at least one wavelength, either directly or indirectly, from the first and second optical fiber paths; and selectively choosing signals from, either directly or indirectly, either the first or second optical fiber paths depending on the optical signals received from the first or second optical fiber path.

This application claims priority to provisional application No. 60/518,503 filed Nov. 7, 2003 and entitled “Equipment and Architecture for Resilient Carrier-Class Scalable Metropolitan Area Optical Ethernet Network,” which is herein incorporated by reference.

### FIELD OF THE INVENTION

The present invention relates generally to a system and method for communication and specifically to a system and method for establishing an optical Ethernet network.

### BRIEF DESCRIPTION OF THE FIGURES

FIG. 1 is a block diagram illustrating a resilient optical Ethernet transport switching (OETS) apparatus 100, according to one embodiment of the invention.

FIG. 2 illustrates the MUX switch 115 in the absence of a redundancy module 120, according to one embodiment of the invention.

FIG. 3A illustrates the circuitry of optical signal detector 249, according to one embodiment of the invention.

FIG. 3B illustrates a method performed by optical signal detector 249, according to one embodiment of the invention.

FIG. 4 illustrates the logic employed by switching logic generator 250, upon receiving the detector signals SD1 and SD2 corresponding to fibers 705 and 715, respectively, where an optional redundancy module is not used, according to one embodiment of the invention.

FIG. 5 illustrates a MUX switch 115 with a redundancy module 120, according to one embodiment of the invention.

FIG. 6 illustrates the protection switching logic of each SLES circuit 510, where an optional redundancy module is used, according to one embodiment of the invention.

FIG. 7 illustrates a resilient optical Ethernet ring network 700 with fibers 705 and 715, according to one embodiment of the invention.

FIG. 8 illustrates an Ethernet virtual topology corresponding to a resilient optical Ethernet ring network, according to one embodiment of the invention.

FIG. 9 illustrates an Ethernet mesh topology corresponding to a resilient optical Ethernet ring network, according ton one embodiment of the invention.

FIG. 10 illustrates an Ethernet linear topology corresponding to a resilient optical Ethernet ring network, according ton one embodiment of the invention.

FIG. 11 illustrates a restoration event when there is a fiber cut in the same location, at both fiber 705 and fiber 715, according to one embodiment of the invention.

### DETAILED DESCRIPTION OF EMBODIMENTS OF THE INVENTION

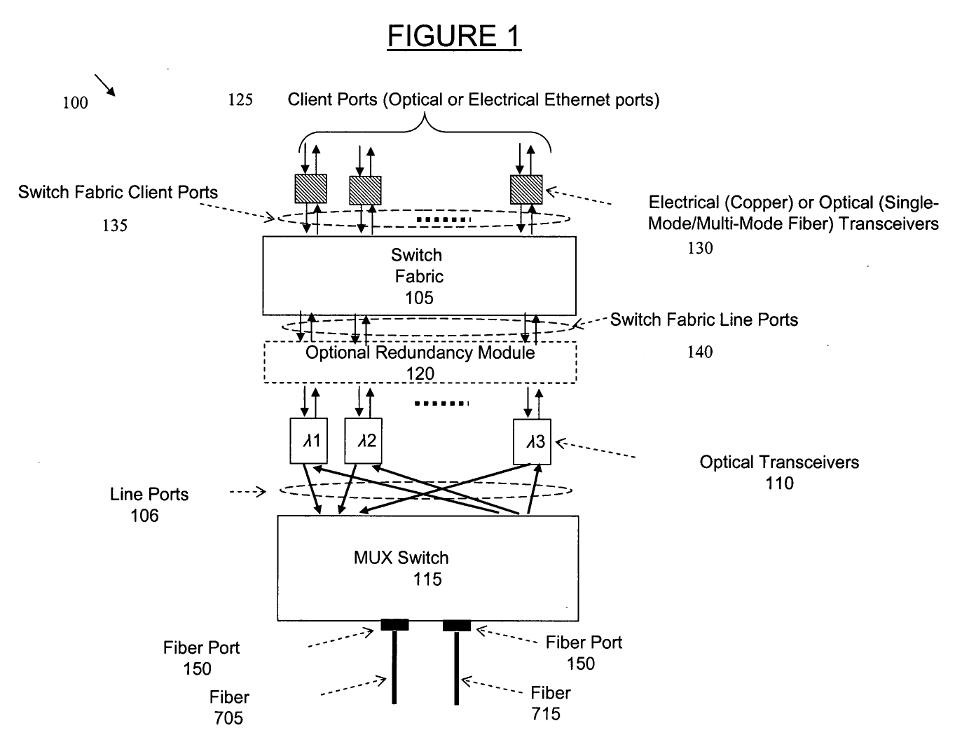

FIG. 1 is a block diagram illustrating a resilient optical Ethernet transport switching (OETS) apparatus 100, according to one embodiment of the invention. The apparatus 100 enables aggregation and switching of a plurality of Ethernet streams (e.g., Fast Ethernet, gigabit Ethernet) into a single or aggregate stream that is transported over a path-protected link in native Ethernet format using optical wavelength division multiplexing (“WDM”). The apparatus 100 can include an Ethernet and/or Layer 3 switch fabric 105 (“switch fabric”) capable of supporting, among other features, link aggregation and spanning tree protocol (“STP); optical transceivers 110 to convert electrical data streams into optical signals at standard specified coarse WDM (“CWDM”) or dense WDM (“DWDM”) wavelengths; and an integrated optical multiplexing/demultiplexing and switching element 115 (“MUX switch”). The apparatus 100 can also include an optional redundancy module 120, which is explained in more detail below. The apparatus 100 can also include a stand-alone Ethernet switch with multiple Ethernet ports. Multiple Ethernet ports included with the switch fabric or with a stand-alone Ethernet switch (“client ports”) connect multiple subscribers/end-users to the apparatus 100. These client ports 125 can support either electrical (e.g., copper) or optical (e.g., single-mode or multi-mode fiber) transceivers 130 connecting the switch fabric 105 to the client ports 125.

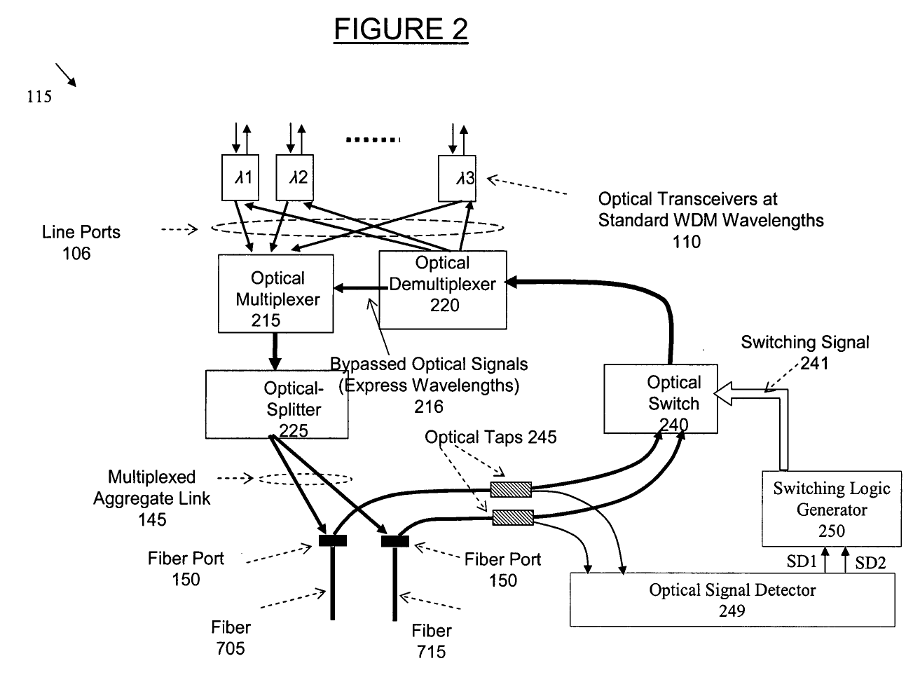

In one embodiment, the outputs of a group of switch fabric line ports 140 are converted from electrical or optical signals into optical signals at standard-specified DWDM and/or CWDM wavelengths through appropriate optical transceivers 110. Alternatively, in another embodiment of the invention, electrical signals to and from switch fabric line ports 140 are received from and sent to a redundancy module 120. Signals from the redundancy module 120 are then converted to optical signals through appropriate optical transceivers 110. If there is more than one switch fabric line port 140, a plurality of the switch fabric line ports 140 can be logically tied together by the switch fabric 105 (utilizing, e.g., IEEE 802.3ad link aggregation protocol), such that a logical higher bandwidth aggregate link is established to connect to the service provider's network. The switch fabric line ports 140 are further multiplexed optically within the MUX switch 115 so that the aggregate link can be transported over a single physical fiber. This logically aggregated and optically multiplexed high-bandwidth link is referred to as a multiplexed aggregate link 145 (see FIG. 2), and is described in more detail below.

FIG. 2 illustrates the MUX switch 115 in the absence of a redundancy module 120, according to one embodiment of the invention. An optical multiplexer 215 receives signals from optical transceivers 110 and integrates the signals into the multiplexed aggregate link 145. The MUX switch 115 supports a first bi-directional fiber 705 and a second bi-directional fiber 715. Of course, in other embodiments, any number of optical fiber segments may be employed. An optical demultiplexer 220 receives optical signals from fibers 705 and 715, indirectly through optical switch 240, and frequency divides the signals for transceivers 110. Demultiplexer 220 passes those frequency components not corresponding to transceivers 110 to optical multiplexer 215 by bypass 216, so that the bypassed frequency components are inserted into the multiplexed aggregate link 145. Multiplexed aggregate link data 145 from the optical multiplexer 215 is split into two streams using an optical splitter 225 and transmitted to both the first fiber 705 and the second fiber 715. In contrast, incoming data from the first fiber 705 and the second fiber 715 is sent to the two fiber input ports 150 of an optical switch 240. Also, a fraction of the incoming optical signals from the first fiber 705 and the second fiber 715 are tapped using optical taps 245, detected using an optical signal detector 249, and passed to a switching logic generator 250. Based on the presence or absence of incoming signals from the fibers 705 and 715, the switching logic generator 250 controls the optical switch 240 to pick a signal from one of the two fibers 705 and 715 to be passed along to the optical demultiplexer 220. In the case of a loss of signal at the first fiber 705, the switching logic generator 250 sends a switching signal 241 to the optical switch 240 and signals from the second fiber 715 are provided to demultiplexer 220. Path switching for the received optical signal can take place in less than a millisecond.

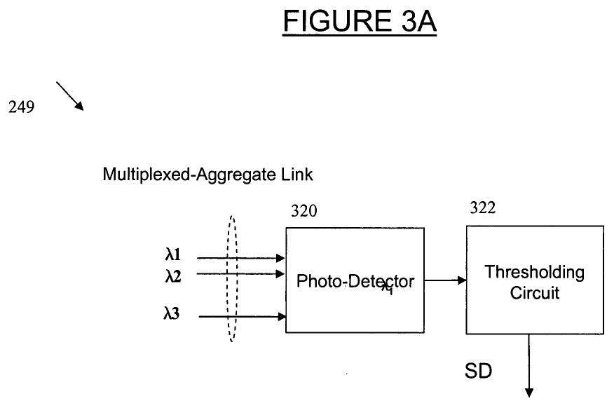

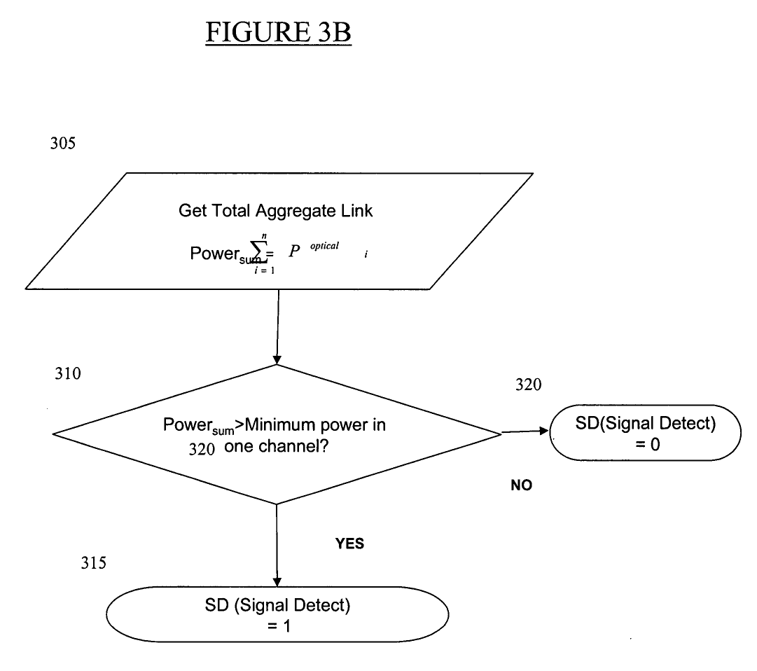

FIG. 3A illustrates the circuitry of optical signal detector 249, according to one embodiment of the invention. Signals from each of fibers 705 and 715 are sent to separate photo-detectors 320. Each photo-detector provides an output signal representing the sum of the powers of the frequencies received from each fiber. The output signal from each photo-detector 320 is provided to a thresholding circuit 322. Thresholding circuit 322 produces a threshold signal SD whose value depends on whether the signal from the photo-detector 320 is greater than the threshold.

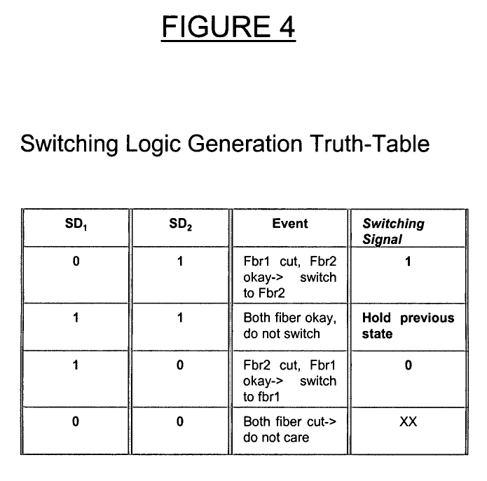

FIG. 3B illustrates a method performed by optical signal detector 249, according to one embodiment of the invention. In step 305, a value is determined corresponding to the sum of the powers of various wavelengths from a corresponding fiber 705 or 715. In step 310, it is determined if the incoming signal level in the corresponding fiber 705 or 715 is above a predetermined threshold level. If so, in step 315, a signal detect (SD) signal is asserted (i.e., set to 1) for the corresponding fiber. If not, in step 320, the corresponding SD signal is de-asserted (i.e., set to 0). FIG. 4 illustrates the logic employed by switching logic generator 250, upon receiving the detector signals SD1 and SD2 corresponding to fibers 705 and 715, respectively, where an optional redundancy module is not used, according to one embodiment of the invention. If both fibers 705 and 715 have valid optical signal present, and thus SD1 is 1 and SD2 is 1, then the switching logic generator 250 generates a signal for the optical switch 240 to hold the previous state. If there is insufficient signal in only one of the two fibers 705 and 715, then SD1 is 1 and SD2 is 0, or SD1 is 0 and SD2 is 1, and the switching logic generator 250 generates a signal so that the optical switch 240 switches to the input fiber that is set to 1 and has a valid signal. Thus, the MUX switch 115 guarantees that as long as one of the fibers 705 and 715 is carrying a valid optical signal, that signal is presented to the optical demultiplexer 220 so that appropriate incoming data is presented to the switch fabric 105. This switching process can take less than 1 millisecond to execute. If both the fibers 230 have an invalid optical signal present, and thus SD1 is 0 and SD2 is 0, then the network is deemed non-functional.

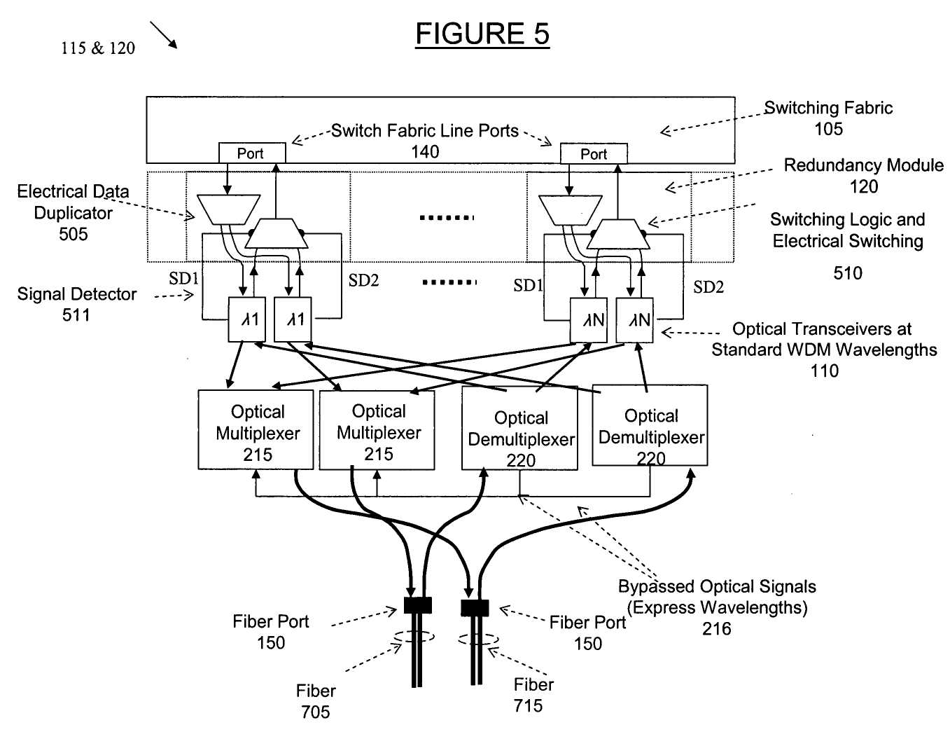

FIG. 5 illustrates a MUX switch 115 with a redundancy module 120, according to one embodiment of the invention. The redundancy module 120 carries out all the protection switching operations on a per-port basis. For every switch fabric line port 140 going into the switching fabric 105, there is a redundancy module 120. Each redundancy module 120 consists of an electrical data duplicator (EDD) circuit 505, a switching logic and electrical switching (SLES) circuit 510, and a signal detector 511. Outbound electrical data from the switch fabric line ports 140 are fed to the EDD circuit 505 to generate two electrical data streams identical to the input streams. Corresponding to every switch fabric line port 140 and redundancy module 120, there are two identical optical transceivers 110. The two identical optical transceivers 110 receive the outbound electrical data streams from the EDD circuit 505 and convert it to identical optical data operating at the same wavelength. The pair of optical transceivers 110 corresponding to each of the switch fabric line ports 140 operate at a preassigned identical wavelength. These optical data streams are then fed into two identical optical multiplexers 215. Each of the optical multiplexers 215 multiplex the optical data at different wavelengths from one of the two identical optical transceivers 110 corresponding to each switch fabric line port 140 and EDD circuit 505. The multiplexed optical data streams from the two optical multiplexers 215 are fed to the two fiber port 150.

Incoming optical signals from the two fiber ports 150 are sent to two identical optical demultiplexers 220. Optical data that is carried on wavelengths that are not preassigned to any of the switch fabric line ports 140 are bypassed by the optical demultiplexers 220 and fed back to the optical multiplexers 215 to be combined with outbound optical data from the switch fabric line-ports 140 and sent back to the fiber ports 150. Optical data at pre-assigned optical wavelengths are demultiplexed at the each of the two optical demultiplexers 220 and sent to the optical transceivers 110 at corresponding switch fabric line ports 140. Thus each of the two optical transceivers 110 corresponding to a switch fabric line port 140 receives optical signals at the same wavelength and converts it to an electrical data stream. Each of the optical transceivers 110 also monitors for the presence of a valid optical signal at the input and generates a signal detect (SD) signal (e.g., SD1 and SD2) based on the electrical data stream from the pair of optical transceivers 110 at switch fabric line ports 140 that are input to the switching logic and electrical switching (SLES) circuit 510. SLES circuit 510 passes signals indirectly from either optical fiber 705 or optical fiber 715 to switch fabric line ports 140.

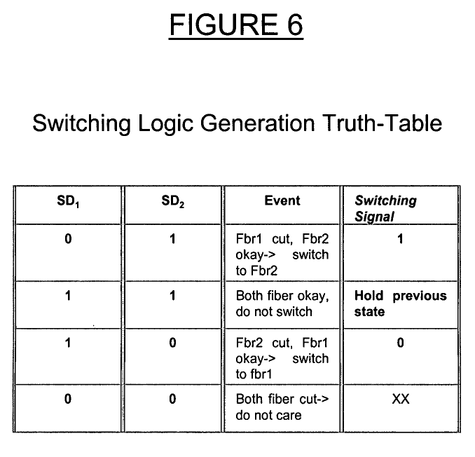

FIG. 6 illustrates the protection switching logic of each SLES circuit 510, where an optional redundancy module is used, according to one embodiment of the invention. The protection switching is done at the SLES circuit 510. If the SLES circuit 510 receives valid SD signals from both the transceivers, SD1 is 1, and SD2 is 1. Thus, both the SD signals are asserted and the switching logic generates a signal for the electrical switch to hold the previous state and continue sending one of the two received electrical signals to the switch fabric line ports 140. If there is insufficient signal in only one of the two fibers, then SD1 is 1 and SD2 is 0, or SD1 is 0 and SD2 is 1, and the SLES circuit 510 generates a signal so that the electrical switch switches to whichever of fiber 705 and 715 has its SD set to 1 and that has valid signal. Thus, the SLES circuit 510 guarantees that as long as one of the two input fibers 705 and 715 is carrying valid optical signal, appropriate incoming data is presented to the switch fabric 105. This switching process can take less than 1 millisecond to execute. If both the fibers 705 and 715 have invalid optical signals present, and thus SD1 is 0 and SD2 is 0, then the network is deemed non-functional.

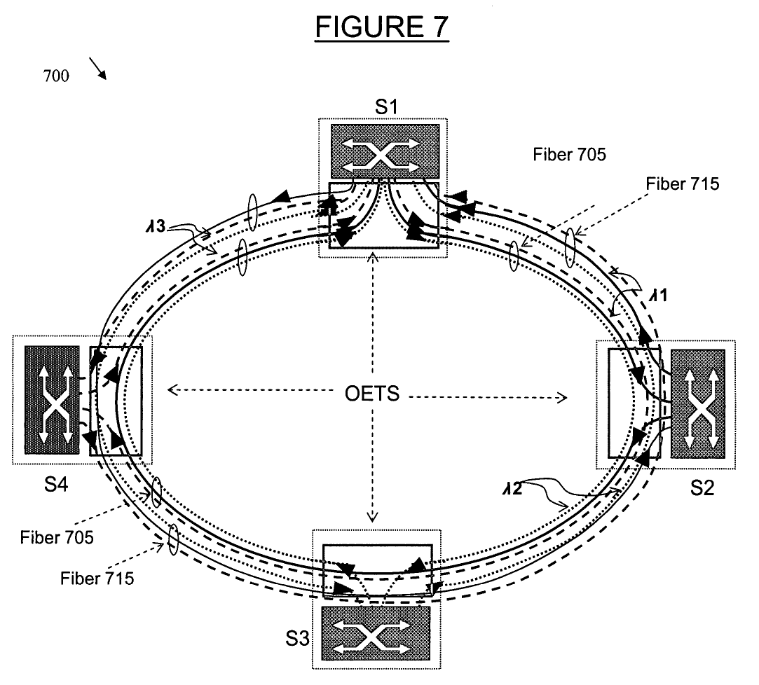

FIG. 7 illustrates a resilient optical Ethernet ring network 700 with fibers 705 and 715, according to one embodiment of the invention. Of course, other embodiments may employ any number of fiber rings. The network 700 comprises fiber 705, fiber 710, and several OETS nodes S1, S2, S3, and S4. A connection between two OETS nodes is established by using one or more line ports 106 operating at one or more pre-assigned dedicated wavelengths λ1, λ2, λ3, . . . , λN. These wavelengths are not re-used for connectivity between any other nodes. For example, in order to establish connectivity between switches S1 and S2, outbound signals from the line ports 106 in S1 are sent to fiber 705 in the clockwise direction. At the same time, exact replicas of the optical signals are also sent in the anti-clockwise direction to fiber 715. At S2, signals carried at wavelengths pre-assigned to S2 are extracted from the clockwise fiber 705 as well as the anti-clockwise fiber 715. S2 passes along all the other wavelengths, including wavelengths that were being pre-used by the fiber to carry other types of traffic (e.g., SONET, FiberChannel) described here as the express wavelengths, on both fibers 705 and 715. If valid optical signals are received from both the fibers 705 and 715, the OETS device, through either the MUX switch 115 or the redundancy-module 120, selects signals from one of the two fibers 705 or 715, as described in FIGS. 2-6. Because all wavelengths carrying data from S1 to S2 that are intended for S2 are dropped from the fibers 705 and 710 at S2, the corresponding capacity in the fiber opens up. The OETS module S2 then transmits the outgoing data to S1 on the same wavelengths that were dropped at the input port. These transmitted wavelengths are multiplexed with the express wavelengths inside the OETS, as described in FIGS. 2 and 5-6, and are carried on the fibers 705 and 715. Thus, an active bi-directional connectivity is established between S1 and S2 in the clockwise fiber 705 and a bi-directional connectivity is established on the counter-clockwise fiber 715. Other pairs of switches establish connectivity in the same way. Thus, through proper wavelength mapping between the OETS pairs, a virtual Ethernet network topology is established over the fiber 705. An exact replica of the Ethernet network topology is also pre-established in the fiber 715.

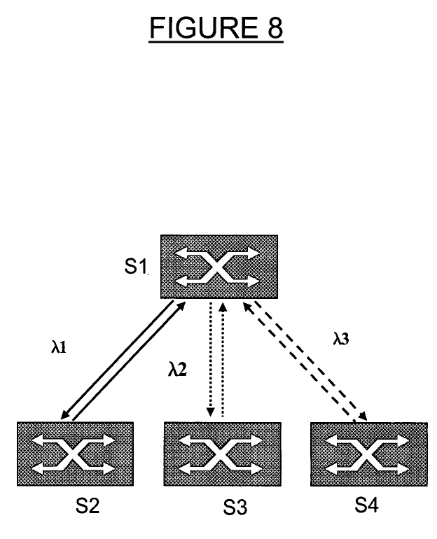

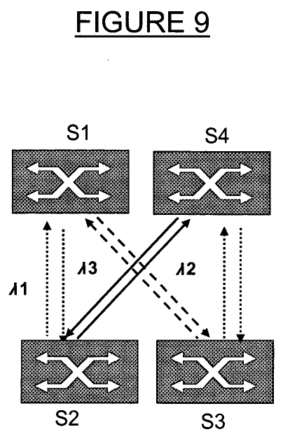

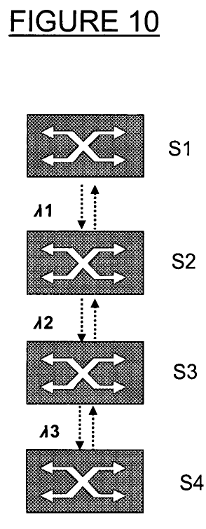

FIG. 8 illustrates an Ethernet virtual topology corresponding to a resilient optical Ethernet ring network, according to one embodiment of the invention. One OETS node (S1) is designated as the master OETS node. Each other OETS node corresponds to one or more optical wavelength(s). Either a multiplexed aggregate link or a single Ethernet link on a single wavelength is used to connect the master OETS node (S1) to the other OETS nodes (S2, S3, S4) on the same fiber 705 or 715. Thus, a logical tree or hub-and-spoke Ethernet network topology is established over the physical fibers 705 and 715. In the embodiment illustrated in FIG. 8, S1 and S2 use λ1 to send data to each other, S1 and S3 use λ2 to send data to each other, and S1 and S4 use λ3 to send data to each other. In a mesh topology, as illustrated in FIG. 9, S1 and S2 use λ1 to send data to each other, S1 and S3 use λ2 to send data to each other, S2 and S4 use λ3 to send data to each other, and S4 and S3 use λ4 to send data to each other. In a linear topology, illustrated in FIG. 10, S1 and S2 use λ1 to send data to each other, S2 and S3 use λ2 to send data to each other, and S3 and S4 use λ3 to send data to each other. Any combination of these virtual Ethernet topologies or any other Ethernet topology not illustrated in FIGS. 5-10, can be supported by the resilient Ethernet ring network described in this invention through proper wavelength mapping.

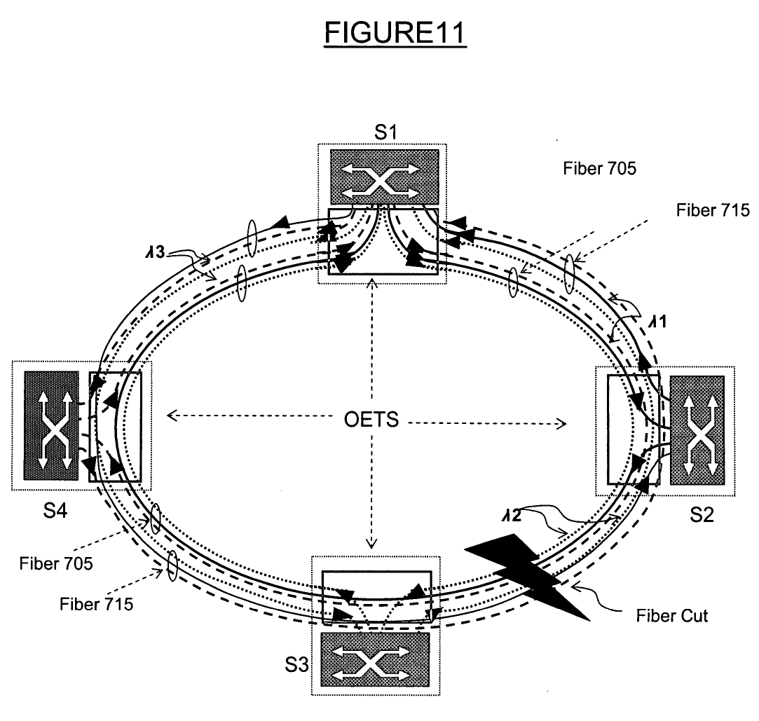

FIG. 11 illustrates a restoration event when there is a fiber cut in the same location (e.g., between nodes S2 and S3) at both fiber 705 and fiber 715, according to one embodiment of the invention. This is the same Ethernet virtual tree network described before and illustrated in FIGS. 7 and 8, but with a fiber break. Whenever a fiber break or wavelength failure occurs, this event is detected at every OETS node from the loss of optical data and the OETS receive port automatically switches to the optical data from the fiber which is still transmitting data. This switching event can take place at every OETS node within 1 millisecond or less from the occurrence of the fiber or wavelength failure. However, as the designated wavelengths being added or dropped at every OETS node remain unchanged, the logical topology of the Ethernet network remains unchanged.

Turning to the details of FIG. 11, as a result of the fiber cut between nodes S2 and S3, optical data from node S2 to S1 carried in the clockwise direction over wavelength λ1 will not reach the receiving port at S1 anymore. Similarly, signals from S1 to S3, carried over wavelength λ2 and from S1 to S4, , carried over wavelength λ3, both in the clockwise direction, disappear. However, as soon as the receiving port of S1 detects the absence of optical signal on wavelength λ1 from fiber 705, the MUX switch module 115 or the redundancy module 120 automatically switches to the anticlockwise fiber 715 and starts receiving data on wavelength λ1. Thus, the bi-directional Ethernet data link between nodes S1 and S2 is automatically reestablished. Bi-directional Ethernet data connections are re-established between nodes S1-S3, and also nodes S1-S4. All the Ethernet connections can be restored within 1 millisecond. After the automatic protection switching, the Ethernet network is reestablished without any change in the virtual tree topology.

Conclusion. The foregoing description should be considered as illustrative only. The invention may be configured in a variety of shapes and sizes and is not limited by the dimensions of the disclosed embodiments. Numerous applications of the invention will readily occur to those skilled in the art. Therefore, it is not desirous to limit the invention to the specific embodiments disclosed or the exact construction and operation shown and described. Rather, all suitable modifications and equivalents may be resorted to, falling within the scope of the invention.

In addition, it should be understood that the figures, which highlight the functionality of the present invention, are presented for example purposes only. The architecture of the present invention is sufficiently flexible and configurable, such that it may be utilized in ways other than that shown in the accompanying figures.

Further, the purpose of the Abstract of the Disclosure is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The Abstract of the Disclosure is not intended to be limiting as to the scope of the present invention in any way.

1. An optical Ethernet network system, comprising:
a plurality of nodes;
at least a first plurality of optical fiber segments connecting the nodes in a ring; and
at least a second plurality of optical fiber segments connecting the nodes in a ring;
each of the nodes adapted to receive optical signals of at least one wavelength, each of the nodes comprising:
at least one optical signal transmitter for generating optical signals of at least one wavelength corresponding to at least one wavelength at which another of the nodes receives optical signals;
transmission paths providing optical signals from the at least one optical signal transmitter to the first and second plurality of optical fiber segments, the transmitting paths sending optical signals in one direction on the first plurality of optical fiber segments, and the transmitting paths sending optical signals in the opposite direction on the second plurality of optical fiber segments;
at least one demultiplexer connected to receive optical signals either directly or indirectly from one of the first and second plurality of optical fiber segments; and
at least one switch for selectively choosing signals either directly or indirectly from either the first or second plurality of optical fiber segments depending on the signals received from the first and second plurality of optical fiber segments.

2. The system of claim 1, wherein wavelength mapping over the first plurality of optical fiber segments and the second plurality of optical fiber segments is performed using a topology where a first of the plurality of nodes and a second of the plurality of nodes use a first wavelength to send data to each other, and the first node and a third of the plurality of nodes use a second wavelength to send data to each other.

3. The system of claim 1, wherein wavelength mapping over the first plurality of optical fiber segments and the second plurality of optical fiber segments is performed using a topology where a first of the plurality of nodes and a second of the plurality of nodes use a first wavelength to send data to each other, the first node and a third of the plurality of nodes use a second wavelength to send data to each other, the second node and a fourth of the plurality of nodes use a third wavelength to send data to each other, and the fourth node and the third node use a fourth wavelength to send data to each other.

4. The system of claim 1, wherein wavelength mapping over the first plurality of optical fiber segments and the second plurality of optical fiber segments is performed using a topology where a first of the plurality of nodes and a second of the plurality of nodes use a first wavelength to send data to each other, the second node and a third of the plurality of nodes use a second wavelength to send data to each other, and the third node and a fourth of the plurality of nodes use a third wavelength to send data to each other.

5. The system of claim 1, wherein the at least one demultiplexer outputs express optical signals received from the first and second plurality of optical fiber segments that do not correspond to the at least one wavelength and the express optical signals are applied to the first and second plurality of optical fiber segments.

6. The system of claim 1, wherein each node further comprises:
optical taps for tapping a fraction of incoming optical signals from the first plurality of optical fiber segments and the second plurality of optical fiber segments;
an optical signal detector for detecting the levels of the incoming signals; and
a switching logic generator for controlling the at least one switch to select an optical signal from one of the two plurality of optical fiber segments and pass the selected optical signal along to the at least one demultiplexer.

7. The system of claim 1, wherein in each node, the at least one demultiplexer includes a demultiplexer connected to each of the pluralities of optical fiber segments, respectively, and each node further comprises:
at least one group of receivers, one of the at least one group of receivers connected to each of the multiplexers, respectively, for converting optical signals into electrical signals; and
at least one switching logic circuit for receiving the electronic signals from the at least one pair of receivers, determining if one or more of the electronic signals are valid, and outputting to the at least one switch a signal indicating if one or more of the electronic signals are valid.

8. The system of claim 7, wherein the at least one switching logic circuit:
outputs a signal to the at least one switch indicating a previous state should be held if all of the electronic signals are valid; and
outputs a signal to the at least one switch to switch to the first or second plurality of optical fiber segments corresponding to a valid signal if only one of the electronic signals is valid.

9. A node system in an optical Ethernet network, comprising:
at least one optical signal transmitter which generates optical signals of at least one wavelength corresponding to at least one wavelength at which another of the nodes receives optical signals;
transmission paths providing optical signals from the at least one optical signal transmitter to first and second optical fiber paths;
at least one demultiplexer connected to receive the optical signals, either directly or indirectly, from one of the first and second optical fiber paths; and
at least one switch for selectively choosing signals, either directly or indirectly, from either the first or second optical fiber paths depending on the signals received from the first and second optical fiber paths.

10. The system of claim 9, wherein the at least one demultiplexer outputs express optical signals received from the first and second optical fiber paths that do not correspond to the at least one wavelength and the express optical signals are applied to the first and second optical fiber paths.

11. The system of claim 9, further comprising:
optical taps for tapping a fraction of incoming optical signals from the first optical fiber path and the second optical fiber path;
an optical signal detector for detecting the levels of the incoming signals; and
a switching logic generator for controlling the at least one switch to select an optical signal from one of the two optical fiber paths and pass the selected optical signal along to the at least one demultiplexer.

12. The system of claim 9, wherein the at least one demultiplexer includes a demultiplexer connected to each of the optical fiber paths, respectively, and the node further comprises:
at least one group of receivers, one of the at least one group of receivers connected to each of the multiplexers, respectively, for converting optical signals into electrical signals; and
at least one switching logic circuit for receiving the electronic signals from the at least one group of receivers, determining if one or more of the electronic signals are valid, and outputting to the at least one switch a signal indicating if one or more of the electronic signals are valid.

13. The system of claim 12, wherein the at least one switching logic circuit:
outputs a signal to the at least one switch indicating a previous state should be held if all of the electronic signals are valid; and
outputs a signal to the at least one switch to switch to the first or second optical fiber paths corresponding to a valid signal if only one of the electronic signals is valid.

14. A method for transmitting optical signals over an Ethernet network system having a plurality of nodes connected in a ring utilizing at least a first plurality of optical fiber segments, a plurality of nodes also being connected in a ring utilizing at least a second plurality of optical fiber segments, each of the nodes being adapted to receive optical signals of at least one wavelength, the method comprising:
generating optical signals of the at least one wavelength corresponding to the at least one wavelength at which another of the nodes receives optical signals;
providing optical signals to the first and second plurality of optical fiber segments, the optical signals being sent in one direction on the first plurality of optical fiber segments, and the optical signals being sent in the opposite direction on the second plurality of optical fiber segments;
receiving optical signals having the at least one wavelength, either directly or indirectly, from the first and second plurality of optical fiber segments; and
selectively choosing signals, either directly or indirectly, from either the first or second plurality of optical fiber segments depending on the signals received from the first and second plurality of optical fiber segments.

15. The method of claim 14, wherein wavelength mapping over the first plurality of optical fiber segments and the second plurality of optical fiber segments is performed using a topology where a first of the plurality of nodes and a second of the plurality of nodes use a first wavelength to send data to each other, and the first node and a third of the plurality of nodes use a second wavelength to send data to each other.

16. The method of claim 14, wherein wavelength mapping over the first plurality of optical fiber segments and the second plurality of optical fiber segments is performed using a topology where a first of the plurality of nodes and a second of the plurality of nodes use a first wavelength to send data to each other, the first node and a third of the plurality of nodes use a second wavelength to send data to each other, the second node and a fourth of the plurality of nodes use a third wavelength to send data to each other, and the fourth node and the third node use a fourth wavelength to send data to each other.

17. The method of claim 14, wherein wavelength mapping over the first plurality of optical fiber segments and the second plurality of optical fiber segments is performed using a topology where a first of the plurality of nodes and a second of the plurality of nodes use a first wavelength to send data to each other, the second node and a third of the plurality of nodes use a second wavelength to send data to each other, and the third node and a fourth of the plurality of nodes use a third wavelength to send data to each other.

18. The method of claim 14, wherein express optical signals, received from the first and second plurality of optical fiber segments, and that do not correspond to the at least one wavelength output on the first and second plurality of optical fiber segments.

19. The method of claim 14, further comprising:
tapping a fraction of incoming optical signals from the first plurality of optical fiber segments and the second plurality of optical fiber segments; and
detecting the levels of the incoming signals, the selectively choosing being responsive to the detecting.

20. The method of claim 14, wherein the receiving includes separately receiving optical signals having the at least one wavelength from each of the first and second plurality of optical fiber segments, the method further comprising:
converting each of the separate optical signals into electrical signals;
determining if one or more of the electronic signals are valid; and
controlling the selective choosing based on the determining.

21. The method of claim 20, further comprising:
outputting a signal to indicating a previous selective choosing should be held if all of the electronic signals are valid; and
outputting a signal causing the selective choosing to choose signals from the first or second plurality of optical fiber segments corresponding to a valid signal if only one of the electronic signals is valid.

22. A method for operating a node in an optical Ethernet network system, comprising:
generating optical signals of at least one wavelength corresponding to the node;
transmitting the optical signals on each of the first and second optical fiber paths;
receiving optical signals of the at least one wavelength, either directly or indirectly, from the first and second optical fiber paths; and
selectively choosing signals from, either directly or indirectly, either the first or second optical fiber paths depending on the optical signals received from the first or second optical fiber path.

23. The method of claim 22, wherein express optical signals, received from the first and second optical fiber paths, and that do not correspond to the at least one wavelength are output to the first and second optical fiber paths.

24. The method of claim 22, further comprising:
tapping a fraction of incoming optical signals from the first optical fiber path and the second optical fiber path;
detecting the levels of the incoming signals, wherein the selective choosing is based on the detecting.

25. The method of claim 22, comprising:
converting the optical signals received in the receiving into electrical signals;
determining if one or more of the electronic signals are valid; and
outputting a signal indicating if one or all of the electronic signals are valid, the selective choosing being based on the determining.

26. The method of claim 25, wherein the outputting further comprises:
outputting a signal indicating a previous state should be held if all of the electronic signals are valid; and
outputting a signal to switch to the optical fiber path corresponding to a valid signal if only one of the electronic signals is valid.

27. An optical Ethernet network system, comprising:
a plurality of nodes;
at least a first plurality of optical fiber segments connecting the nodes in a ring; and
at least a second plurality of optical fiber segments connecting the nodes in a ring;
each of the nodes adapted to receive and transmit optical signals of at least one wavelength corresponding to at least one wavelength at which another of the nodes receives and transmits optical signals, each of the nodes comprising:
an optical demultiplexer connected to each one of the first and second plurality of optical fiber segments, respectively, to output optical signals of the at least one wavelength;
at least one group of transceivers, wherein each transceiver of each group receives optical signals from one of the optical demultiplexers, respectively, and converts the optical signals into electrical signals, each group of transceivers also converting electrical signals into optical signals of the at least one wavelength;
at least one switch for receiving electrical signals from the transceivers in the at least one group of transceivers and passing one of the electrical signals which is valid; and
an optical multiplexer, connected to each one of the first and second plurality of optical fiber segments, respectively, and receiving optical signals from one transceiver in the at least one group of transceivers and sending the optical signals in one direction on the first plurality of optical fiber segments and sending the optical signals in the opposite direction on the second plurality of optical fiber segments.

28. The system of claim 27, wherein each optical demultiplexer transmits optical signals not of the at least one wavelength to each optical multiplexer for sending on the first and second plurality of optical fiber segments.

29. An optical Ethernet network system, comprising:
a plurality of nodes;
a first plurality of optical fiber segments connecting the nodes in a ring;
a second plurality of optical fiber segments connecting the nodes in a ring;
each of the nodes adapted to receive and transmit optical signals of at least one wavelength corresponding to a wavelength at which another of the nodes receives and transmits optical signals, each of the nodes comprising:
an optical switch connected to the first and second plurality of optical fiber segments for outputting optical signals from one of the first and second plurality of optical fiber segments which are valid;
an optical demultiplexer connected to the optical switch and selecting optical signals having the at least one wavelength;
at least one transceiver for converting optical signals of the at lest one wavelength from the optical demultiplexer into input electrical signals, and for converting output electrical signals into output optical signals of the at least one wavelength; and
transmission paths providing the output optical signals to the first and second plurality of optical fiber segments, the transmitting paths sending optical signals in one direction on the first plurality of optical fiber segments, and the transmitting paths sending optical signals in the opposite direction on the second plurality of optical fiber segments.

30. The system of claim 29, wherein the optical demultiplexer transmits optical signals not of the at least one wavelength on each of the first and second plurality of optical fiber segments.
